(19) United States
(12) Patent Application Publication
(10) Pub. No.: US 2025/0224364 A1
(43) Pub. Date: Jul. 10, 2025

(54) ELECTROCHEMICAL TESTING DEVICE WITH WELL INSERTS

(71) Applicant: Automat Solutions, Inc., San Leandro, CA (US)

(72) Inventors: Xuejun Wang, Pleasanton, CA (US); Syahmi Izzat Bin Salleh, Fremont, CA (US); Javier Rivera, Castro Valley, CA (US)

(21) Appl. No.: 19/088,318

(22) Filed: Mar. 24, 2025

Related U.S. Application Data
(63) Continuation-in-part of application No. 17/548,484, filed on Dec. 10, 2021, now Pat. No. 12,259,348.
Application No. 17/548,484 is a continuation-in-part of application No. 17/204,858, filed on Mar. 17, 2021.
(60) Provisional application No. 63/040,133, filed on Jun. 17, 2020.

(51) Int. Cl. G01N 27/413; B01L 3/00; G01N 27/416

(52) U.S. Cl. CPC G01N 27/413; B01L 3/5055; G01N 27/416

(57) ABSTRACT

An electrochemical testing device can include a bottom electrochemical block, a top electrochemical block, and a plurality of well inserts. The bottom electrochemical block can have multiple wells, each being configured to receive therein a prepared liquid electrolyte suitable for electrochemical testing. The top electrochemical block can have multiple chambers and can be configured for fastening onto the bottom electrochemical block such that the multiple chambers align with the multiple wells to form multiple testing cells. Each well insert can be configured to be removably placed within a testing cell to facilitate normalizing its respective testing cell such that all testing cells having a well insert provide electrochemical testing parameters that are substantially identical. Each well insert can include an inner spacer, an outer spacer, an inner electrode situated therebetween, and an internal testing volume for receiving a liquid electrolyte.

### CROSS-REFERENCE TO RELATED APPLICATIONS

This application is a continuation-in-part of U.S. patent application Ser. No. 17/548,484, filed Dec. 10, 2021, which in turn is a continuation-in-part of U.S. patent application Ser. No. 17/204,858, filed Mar. 17, 2021, which claims the benefit of U.S. Provisional Patent Application No. 63/040,133, filed Jun. 17, 2020, all of which are hereby incorporated by reference in their entireties herein.

### BACKGROUND

Conventional material research and development is mainly driven by human intuition, labor, and manual decision, which is often ineffective and inefficient. Due to the complexity of material design and the magnitude of experimental and computational work, the discovery of materials with conventional methods usually takes long development cycles and requires large human and financial costs.

In the discovery of battery materials like electrolyte, the properties of the material must be measured, such as, e.g., the conductivity and impedance of electrolyte material. This is to ensure that the material meets quality standards. The conventional way to measure such properties for electrolyte, for example, is to prepare a formulation with various powders and solvents, mix them together, and then process the formulation in different ways, such as by heating it. Once the electrolyte material is prepared, it is added to a coin cell battery, with the electrolyte typically placed between the electrodes of the battery. The properties of the coin cell battery can then be measured to see if the electrolyte material is of a sufficiently high-performing quality based on the conductivity of the material and other properties.

This conventional process for battery material formulation is a mainly single-channel manual process, and the material property testing involves serial-based measurement. As a result, this conventional process is very time-consuming, costly, and inefficient. A coin cell-based electrochemical testing process is usually lab-intensive and hard to integrate into a high-throughput testing model. Thus, there is a need in the field of art for a faster, more efficient, and less costly method of measuring the properties of electrochemical material.

### SUMMARY

It is an advantage of the present disclosure to provide faster, more efficient, and less costly systems and methods and of measuring the properties of electrochemical materials. The disclosed features, apparatuses, systems, and methods provide for the improved testing of electrochemical materials, particularly with respect to liquid electrolytes suitable for use in the formation of batteries. These advantages can be accomplished in multiple ways, such as by using well inserts placed within the wells or testing cells of a electrochemical testing device.

Various embodiments described herein are directed to a system, an apparatus, and a method for electrochemical testing. The testing involved is multichannel and matrix-based and is capable of realizing battery material formulation and testing in a parallel high-throughput mode. In some embodiments, it includes a multichannel formulation and electrochemical testing module, a connection box such as, e.g., a clap on fast connection box, and an automatic switch box with control software. This system can mimic a matrix of N×M (such as, e.g., a 2×4 or 4×8 matrix) for the number of coin cells used for robotic formulation and automatic electrochemical property measurement. In some embodiments, this system is used to discover high-performance battery materials, including, e.g., electrolyte, cathode, anode, and battery devices.

A matrix-based, multichannel battery material formulation and testing system can be used to accelerate the research and development of battery material, as well as the time-to-market for products. In some embodiments, the testing system can be used for robotic high-throughput formulation and parallel electrochemical testing. In some embodiments, an automatic switch box can be employed to facilitate this. In some embodiments, the testing system functions to simplify the battery material discovery process, with higher efficiency and faster testing, and with less human involvement.

The traditional battery material (such as, e.g., electrolyte material) formulation is mainly based on a single formulation and is carried out by a battery scientist or technician, who prepares a pipette-dispensed liquid or manually weighed solid materials and adds them into bottles or vials. The formulated materials in the containers (e.g., bottles or vials) is then processed with heating, shaking, etc., and then the materials will be transferred manually to individual coin cells for property testing (conductivity, electrochemical impedance etc.). It is very labor intensive and time consuming, especially for formulating and testing a large number of different material compositions. Usually, a scientist can only formulate and test a few samples each week.

A matrix-based battery material formulation and testing system, combined with, e.g., a robotics driven system in some embodiments, can allow parallelizing many experiments at one time via automation, thus greatly compressing research time. In some embodiments, the system can perform formulation and testing from, e.g., 2 to 96 or more different compositions. This results in much faster throughput in the lab compared with the traditional approach to research and development.

In some embodiments, this testing involves an electrode combined with parallel processing of multiple (e.g., 20, 30, 40, or more) electrolyte materials such that they are all measured simultaneously, resulting in a much faster and more efficient method of testing. In some embodiments, the testing is performed with an electrochemical module consisting of an N×M matrix of testing cells for electrolyte composition to be placed.

One embodiment involves a method and system for electrochemical testing. The method provides an electrochemical testing apparatus that consists of a bottom block having a first array of N×M receiving wells, and a top block with a second array of N×M chambers, with each of the N×M chambers having a top electrical connector and a bottom electrical connector, i.e., a top electrode and a bottom electrode. Thus, each testing channel will have its own top and bottom electrodes. Each channel has two wires connected to the testing device. A top and bottom PCB board connect the 32 channels, and connect to a switch box.

In one embodiment, the method involves inserting, into a number of the first array of N×M receiving wells, one or more electrochemical compositions to be tested. The method then involves closing the top block onto the bottom block. When the top and bottom blocks are closed, the N×M receiving wells and N×M chambers are aligned, thereby forming N×M testing cells. Finally, the method involves measuring one or more properties of the electrochemical composition inserted in the plurality of the N×M receiving wells.

In various embodiments of the present disclosure, an electrochemical testing device can include a bottom electrochemical block, a top electrochemical block, and a plurality of well inserts. The bottom electrochemical block can have multiple wells configured to receive therein a battery material suitable for electrochemical testing. The top electrochemical block can have multiple chambers and can be configured to be fastened onto the bottom electrochemical block such that the multiple chambers align with the multiple wells to form multiple testing cells. The plurality of well inserts can be configured to be removably placed within the multiple testing cells. Each well insert can be configured to facilitate normalizing its respective testing cell when placed therein such that each of the multiple testing cells with a well insert provides electrochemical testing parameters that are substantially identical.

In various detailed embodiments, each of the plurality of well inserts can be configured to facilitate liquid electrolyte testing. The substantially identical electrochemical testing parameters for each of the multiple testing cells can include internal volume, internal pressure, distance between testing cell electrodes, or any combination thereof. Each of the plurality of well inserts can include an inner spacer having a top opening through a top surface thereof configured to receive a liquid electrolyte to be tested and an outer spacer removably coupled to the inner spacer such that the inner spacer and outer spacer combine to define an internal testing volume configured to receive the liquid electrolyte therein via the top opening. Each of the plurality of well inserts can further include an inner electrode situated between the inner spacer and the outer spacer. Each of the inner electrodes can have a protrusion with an electrical contact surface that extends through a bottom opening of the outer spacer. Each inner electrode can form a bottom electrode, and the electrochemical testing device can further include a plurality of top electrodes. Each top electrode can be located within a chamber of the top electrochemical block such that each testing cell includes a top electrode at the top of the testing cell and a bottom electrode at the bottom of the testing cell. The distance between the top electrode and the bottom electrode can be identical for each of the testing cells.

In further detailed embodiments, each of the plurality of well inserts can also include a sealing component situated about the inner electrode to prevent liquid electrolyte from escaping through the bottom opening of the outer spacer. Each outer spacer can be removably coupled to a respective inner spacer by way of threaded arrangements on both of the outer spacer and the inner spacer. The internal testing volume can be identical for each of the plurality of well inserts, and this internal testing volume for each of the plurality of well inserts can remain the same regardless of any variations in the dimensions of the multiple testing cells. In some arrangements, the internal testing volume can be fully contained within the inner spacer.

In various further embodiments of the present disclosure, a well insert configured to be removably placed within a testing cell of an electrochemical testing device can include an inner spacer, an outer spacer, and an inner electrode. The inner spacer can have a top opening through a top surface thereof configured to receive a liquid electrolyte to be tested. The outer spacer can be removably coupled to the inner spacer. The inner spacer and outer spacer can combine to define an internal testing volume configured to receive the liquid electrolyte therein via the top opening. The inner electrode can be situated between the inner spacer and the outer spacer, and this inner electrode can have a protrusion with an electrical contact surface that extends through a bottom opening of the outer spacer. The well insert can be configured to facilitate normalizing a testing cell within an electrochemical testing device having multiple testing cells such that all testing cells having a well insert situated therein provide electrochemical testing parameters that are substantially identical.

In various detailed embodiments, the well insert can further include a sealing component situated about the inner electrode to prevent liquid electrolyte from escaping through the bottom opening of the outer spacer. The outer spacer can be removably coupled to the inner spacer by way of threaded arrangements on both of the outer spacer and the inner spacer. The internal testing volume can be fully contained within the inner spacer, and this internal testing volume can remain the same regardless of the dimensions of the electrochemical testing device testing cell that the well insert is placed within. In some arrangements, the inner electrode can form a bottom electrode for the testing cell, and the top surface of the inner spacer can be configured to contact a separate top electrode for the testing cell.

In still further embodiments of the present disclosure, various methods of testing liquid electrolytes are provided. Pertinent process steps can include providing an electrochemical testing device as set forth above, placing one of the plurality of well inserts into each of the multiple wells of the bottom electrochemical block, inserting a liquid electrolyte into each of the well inserts, closing the top electrochemical block onto the bottom electrochemical block such that the multiple chambers align with the multiple wells to form multiple testing cells, and measuring one or more properties of the liquid electrolytes inserted into each of the well inserts. In some arrangements, further process steps can include placing a top electrode component into each of the multiple chambers of the top electrochemical block, wherein each of the well inserts includes a corresponding bottom electrode component therein, providing a sealing component between the top and bottom electrochemical blocks, and fastening the top electrochemical block to the bottom electrochemical block using one or more coupling components.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems, and methods of use involving an electrochemical test device with well inserts. These drawings in no way limit any changes in form and detail that may be made to the disclosure by one skilled in the art without departing from the spirit and scope of the disclosure.

FIG. 1 illustrates an exemplary embodiment of an electrochemical testing system, accordance to some embodiments.

FIG. 2 illustrates an exemplary embodiment of top and bottom electrochemical blocks of an electrochemical module, according to some embodiments.

FIG. 3 is a diagram illustrating connecting and sealing components used in various embodiments.

FIG. 4 illustrates an exemplary embodiment of a three-dimensional (hereinafter “3D”) drawing of top and bottom electrochemical blocks with a cross-section cut to illustrate when the top and bottom blocks are placed together and sealed, according to some embodiments.

FIG. 5A illustrates an exemplary embodiment of a printed circuit board placed in a connection box with an electrochemical formulation and testing module, according to some embodiments.

FIG. 5B illustrates an exemplary embodiment of a printed circuit board placed in a connection box with an electrochemical formulation and testing module, according to some embodiments.

FIG. 6A illustrates an exemplary embodiment of an automatic switch box, according to some embodiments.

FIG. 6B illustrates an exemplary embodiment of a control software interface for an automatic switch box, according to some embodiments.

FIG. 6C illustrates a diagram representing an exemplary wiring configuration for an automatic switch box, according to some embodiments.

FIG. 7A illustrates a top view of a bottom block, in accordance with some embodiments.

FIG. 7B illustrates a top view of a top block, in accordance with some embodiments.

FIG. 7C illustrates a top view of a top and bottom block fastened together, in accordance with some embodiments.

FIG. 8A illustrates a PCB board representing an N×M matrix of testing cells, in accordance with some embodiments.

FIG. 8B illustrates a plunger which connects to each of the receiving wells, in accordance with some embodiments.

FIG. 9 illustrates a prior art embodiment of a 32-channel electrochemical block with manual connections per channel.

FIG. 10 is a flowchart illustrating an exemplary method for multi-channel matrix-based electrochemical testing, in accordance with some embodiments.

FIG. 11 is a diagram illustrating an exemplary computer that may perform processing in some embodiments.

FIG. 12A illustrates in top perspective view an example alternative bottom electrochemical block for an electrochemical testing device according to one embodiment of the present disclosure.

FIG. 12B illustrates in bottom perspective view the alternative bottom electrochemical block of FIG. 12A according to one embodiment of the present disclosure.

FIG. 13A illustrates in front perspective view an example well insert for an electrochemical testing device according to one embodiment of the present disclosure.

FIG. 13B illustrates in perspective exploded view the well insert of FIG. 13A according to one embodiment of the present disclosure.

FIG. 13C illustrates in side cross-section view the well insert of FIG. 13A according to one embodiment of the present disclosure.

FIG. 14A illustrates in top perspective view the alternative bottom electrochemical block of FIG. 12A as being partially assembled with well inserts according to one embodiment of the present disclosure.

FIG. 14B illustrates in close up top plan view the alternative bottom electrochemical block of FIG. 12A with wells at various stages of assembly according to one embodiment of the present disclosure.

FIG. 15A illustrates in perspective exploded view an example top electrode for an electrochemical testing device according to one embodiment of the present disclosure.

FIG. 15B illustrates in side exploded view the top electrode of FIG. 15A according to one embodiment of the present disclosure.

FIG. 16 illustrates a flowchart of an example method of testing liquid electrolytes according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment. Some embodiments are implemented by a computer system. A computer system may include a processor, a memory, and a non-transitory computer-readable medium. The memory and non-transitory medium may store instructions for performing methods and steps described herein.

The present disclosure relates in various embodiments to features, apparatuses, systems, and methods that provide for the improved testing of electrochemical materials, particularly with respect to liquid electrolytes suitable for use in the formation of batteries. These advantages can be accomplished in multiple ways, such as by using well inserts placed within the wells or testing cells of a electrochemical testing device. In particular, the disclosed systems and methods can involve the use of an electrochemical testing device having top and bottom electrochemical blocks with wells and chambers that combine to form multiple testing cells for testing different electrochemical materials such as liquid electrolytes. Because issues can arise with varying properties or parameters from one testing cell to another, removable well inserts can be placed within the wells or testing cells to eliminate or reduce any significant differences between multiple testing cells, thus normalizing all of the testing cells to identical or substantially similar properties or parameters, such as volume, pressure, and the like.

While the disclosed systems and methods illustrate and discuss electrochemical testing devices that include blocks with multiple wells or testing cells arranged into a N×M matrix or grid, it will be readily appreciated that the disclosed embodiments can be used or suitably altered to include multiple wells or testing cells in other formations. Also, while O-rings are used as sealing materials between different components, it will be appreciated that other types of sealing materials or arrangements can alternatively be used. Further, while bolt and nut arrangements are disclosed as one way of fastening top and bottom electrochemical blocks together, other types of block fastening or coupling arrangements are also possible. Still further, other battery materials besides liquid electrolytes can be tested, such as cathodes, anodes, and solid electrolytes. Other extrapolations and variations of the features, components, systems, and methods disclosed herein are also possible, as will be understood by those of skill in the art.

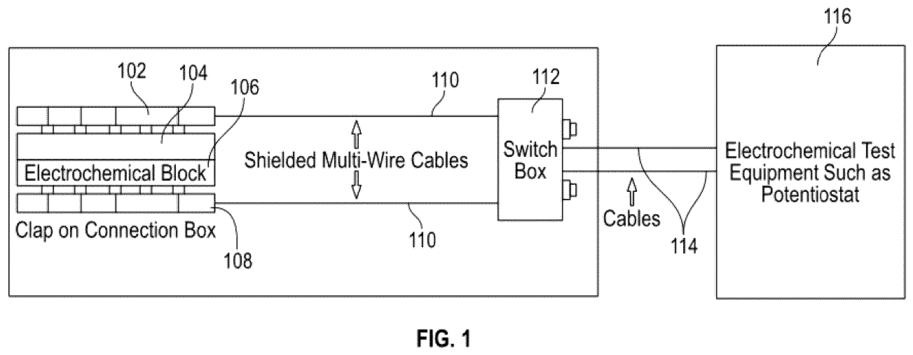

FIG. 1 illustrates an exemplary embodiment of an electrochemical testing system, accordance to some embodiments. The illustrated electrochemical testing system includes a multichannel electrochemical formulation and testing module 102 with a top electrochemical block 104 and a bottom electrochemical block 106, a connection box 108, shielded multi-wire cables 110, a switch box 112, cables 114, and electrochemical test equipment 116.

The multichannel electrochemical formulation and testing module 102 includes a top electrochemical block 104 and bottom electrochemical block 106. The electrochemical formulation and testing module has multiple independent channels in an N×M matrix format (e.g., for example, a 2×4 or 4×6 matrix), allowing for N×M receiving wells with material inside of each.

Electrochemical material, each having an electrochemical composition, is inserted into the receiving wells. According to various embodiments, the electrochemical material may be, e.g., one or more of: polymer electrolyte, liquid electrolyte, cathode, anode, or any other suitable electrochemical material. In various embodiments, each electrochemical material represents battery materials for optimizing at least one objective function, such as, for example: conductivity, lithium transference number, lithium diffusion coefficient, cathodic stability, anodic stability, cost, and/or any other suitable or relevant objective function of battery materials. In some embodiments, the system can be potentially used for electrochemical properties for testing beyond battery materials, such as, e.g., low or high dielectric materials or fuel cell materials. One or more measurement tests are performed on each of the electrochemical compositions placed into the N×M receiving wells.

In various embodiments, an electrode can be placed in the top block 104, the bottom block 106, or both. In some embodiments, the top and/or bottom electrodes are made from conductive metals, such as, e.g., copper. In some embodiments, springs are contained inside the assemblies of the formulation and testing module that connect to electrodes in the top block and/or electrodes in the bottom block to ensure an electrical connection is provided, i.e., conductivity of the electrochemical composition with the electrode(s) is insured.

In some embodiments, a vacuum fitting is present in the formulation and testing module, in the top and/or bottom block. In some embodiments, this vacuum fitting can connect to a vacuum machine in order to create a vacuum-sealed environment inside. In some embodiments, the vacuum fitting is a metal hose which is placed at the center of the module, and this hose is used to connect the block to a vacuum pump. In some embodiments, one or more metal screws are present to tighten the assemblies and the electrode(s) within the module, and to provide a surface to make use of the vacuum pump.

In various embodiments, a square rim style sealing and/or flat rubber rings are present to ensure the sealing of the inside channels, which creates an air-tight seal between the top block 104 and the bottom block 106.

In some embodiments, the connection box 108 includes clap on fast connection blocks for electrochemical testing. In some embodiments, to ensure a sufficiently fast connection of the electrodes on the top and bottom electrochemical blocks, clap on printed circuit board (hereinafter “PCB”) connectors are employed. The PCB connectors include a corresponding number of contact pins (i.e., N×M number of contact pins), with a single output connection port for easy plug-in connection. In some embodiments, a PCB with multiple layers (e.g., 6 layers or more depending on the circuit board design) will be used to ensure that there is no interference between signals from different electrodes.

An automatic switch box 112 is connected to the formulation and testing module 102 via one or more shielded multi-wire cables 110. In some embodiments the switch box 112 includes switching software configured to enable automatic switching between channels for purposes of electrochemical property measurement. In various embodiments, the switch box 112 can allow for, e.g., 4-to-1, 8-to-1, or 32-to-1 input/output correspondence. The automatic switch box 112 enables N×M channels to be measured by electrochemical test equipment 116. In various embodiments, this test equipment 116 can include single-channel or M-channel testing devices, such as, e.g., a potentiostat. The electrochemical test equipment 116 functions to measure properties such as, e.g., conductivities and Electrochemical Impedance Spectroscopy (EIS). In various embodiments, the measurement channel can be automatically switched in various ways, such as by, e.g., a timer, a trigger signal, or a manual process. In some embodiments, the switch box 112 can be controlled via a computer device through, e.g., a serial communication or TCP/IP.

In order to achieve a real battery cell condition, there are multiple critical technical challenges within the system design. These challenges include, at least: a requirement that the module must be air and moisture free; a requirement that the electrodes and the electrolyte materials should be even and well-connected; and a requirement that there is electric insulation between cells. These challenges will be addressed throughout the discussion of the figures below.

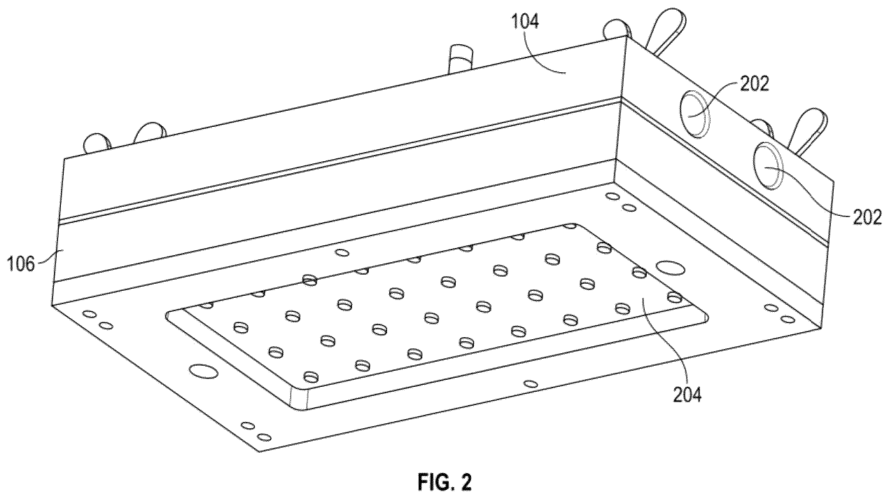

FIG. 2 illustrates an exemplary embodiment of top and bottom electrochemical blocks of an electrochemical module, according to some embodiments.

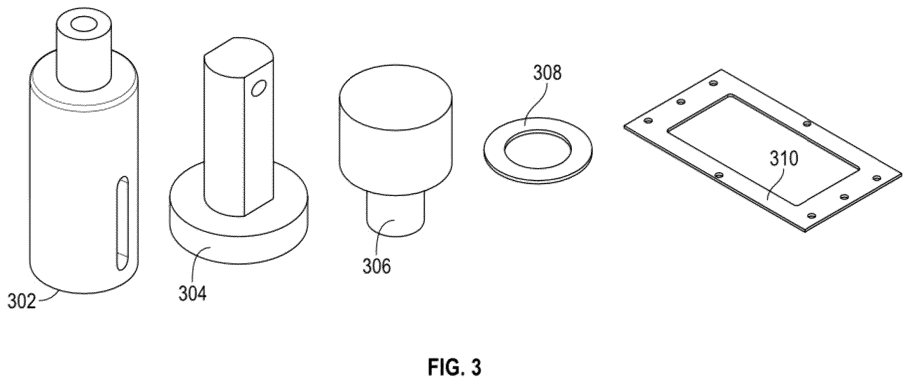

As described above, the electrochemical module 102 is composed of a top electrochemical block 104 and a bottom electrochemical block 106. In some embodiments, these top and bottom blocks are made of Teflon or similar isolating material, to ensure that every channel is properly isolated. The top and bottom blocks each contain N×M number of holes, e.g., 4×8 as illustrated in the figure for 32 channels, with positions well aligned for the top and bottom blocks. In some embodiments, a “T” shaped stainless-steel component, such as, e.g., the T-shaped component 306 in FIG. 3, is inserted into the bottom block 106 to provide one electrode. In some embodiments, a hollow cylindrical fitting component with a sliding hole, such as the cylindrical fitting component 302 in FIG. 3, will be inserted into a hole of the upper block 104. In some embodiments, this component is a hollow and/or stainless-steel piece. In some embodiments, a spring is inserted into the hollow of the cylindrical fitting component, and then a T-shape stainless steel component with a small hole, such as the T shaped component 304 in FIG. 3, is inserted into the hollow of the fitting component 302. The T shaped component 304 is fixed with a small pin inserted into the hole in the “T”, as well as the sliding hole in the fitting component 302. In some embodiments, this “T” component 304 acts as another electrode and has an extended up and down range. In some embodiments, the force created by the spring in each cell guarantees a strong surface contact between the electrode(s) and the electrochemical material. In some embodiments, other components such as a washer separator component 308 and/or a sealing component 310 may additionally be present.

The top and bottom electrochemical blocks can be placed together, i.e., one pressed against the other. These top and bottom blocks are sealed tightly. In various embodiments, these blocks are sealed with an air-tight and moisture-free seal. Many methods of sealing may be contemplated. In some embodiments, the seal may be a vacuum-tight seal. In some embodiments, an air valve can be filled with an inert gas or dry material to create the seal.

In some embodiments, sealing is facilitated with a gasket seal. In some embodiments, when the top and bottom electrochemical blocks are placed together, the top is tough, so a layer of a sealing component 310, such as, e.g., a sealing rubber, is placed between the top and bottom blocks. The sealing gasket will provide a sealing for the top and bottom blocks.

In some embodiments, a washer separator component in inserted between top and bottom electrodes within the top and bottom electrochemical blocks, such as the washer separator component 308 in FIG. 3. A top electrode by design will be able to come into contact with a bottom electrode to create pressure. A polymer may then be inserted between the top and bottom electrodes for creating a conductivity test. However, if liquid is filled in between, with the top electrode attached to the bottom electrode, the electrodes would be touching with no electrolyte between them. Thus, a washer separator component can be inserted in between, such as, e.g., a round, washer-style separator component with a hole. In some embodiments, liquid electrolyte can then be filled between the top and bottom electrode in the hole. A chamber is thus created which has both a top and bottom electrode, with liquid electrolyte in between. Multiple such chambers can be created corresponding to the number of channels for testing. In some embodiments, the washer separator component is a non-conductive material, such as, e.g., Teflon.

In some embodiments, sealing is facilitated with square rim style sealing between the top and bottom blocks. In some embodiments, sealing can be facilitated with usage of Teflon material combined with screws. In some embodiments, the top electrochemical block has a vacuum fitting, such as an air valve or metal hose, which can connect to a vacuum pump to generate a vacuum environment inside the module. Other forms of sealing the top and bottom blocks may be contemplated.

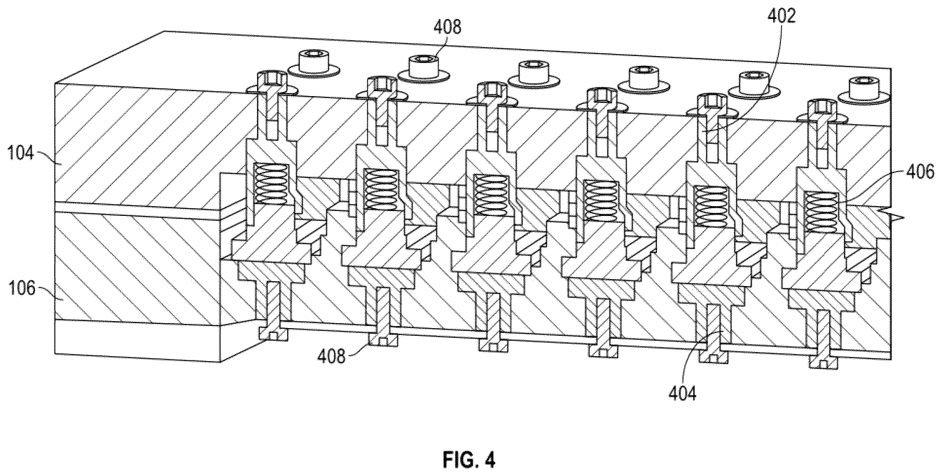

FIG. 4 illustrates an exemplary embodiment of a 3D drawing of top and bottom electrochemical blocks with a cross-section cut to illustrate when the top and bottom blocks are placed together and sealed, according to some embodiments.

For measurement of ionic conductivity, samples of electrochemical material are sandwiched between stainless-steel electrodes. An electrochemical impedance spectrum (EIS) can be collected, from which the ionic conductivity is derived. Since the electrochemical module can have N×M channels, for example, 4×8 or 32 channels, there will be a total of double the channels, e.g., 64 wires needed to be connected. In the example of 32 channels, this amounts to 32 wires in the chambers of the top block 104, and 32 wires in the chambers of the bottom block 106. An easy and secure connection to each channel is provided via clap on connections through a connection box, and each channel is connected to electrochemical test equipment such as, e.g., a potentiostat to ensure fast and reliable measurement.

In the illustrated embodiment, each chamber is shown having a top electrode with spring 406, bottom electrode, and electrolyte. A metal piece connects to a probe, which comes into contact with each metal piece on the top and bottom of the block and connects through a PCB board to the switch box. Electrochemical block screws 408 can be screwed into upper electrode assembly 402 and bottom electrode 404, providing an electrical connection between the top and bottom electrode. In some embodiments, the upper electrode assembly 402 corresponds to the fitting component 302 in FIG. 3. In some embodiments, the bottom electrode 404 corresponds to the T-shaped electrode 306 in FIG. 3. In both such embodiments, a screw can be screwed into the fitting component 302 and the T-shaped electrode 306.

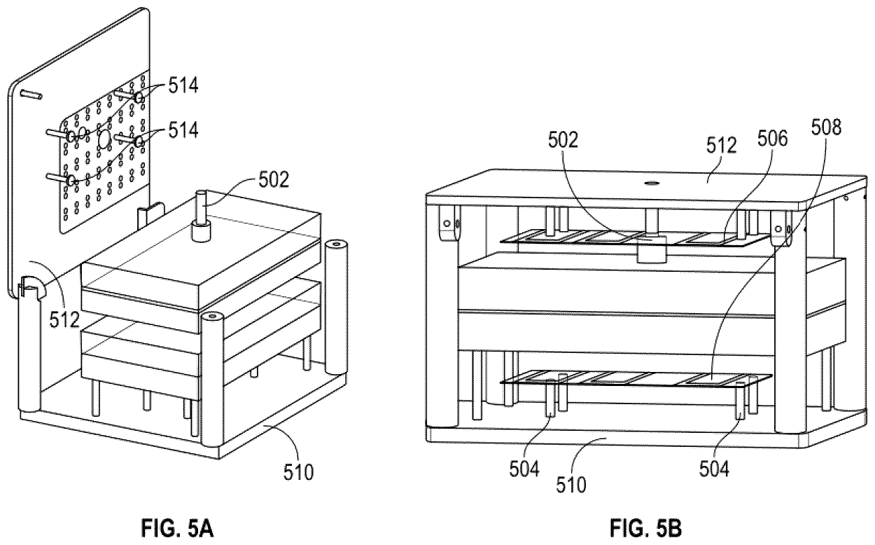

FIGS. 5A and 5B illustrate exemplary embodiments of printed circuit boards placed in a connection box with an electrochemical formulation and testing module, according to some embodiments. FIG. 5A illustrates a PCB 506 in the process of being placed in the connection box, while FIG. 5B illustrates the final state of the PCB placed in the connection box. Multilayer PCBs or connections boards 506 and 508, each with N×M connecting points, are configured to exactly match the channel position of the electrochemical module. In some embodiments, the PCBs will each have wires at inner layers, with a ground layer in the middle to prevent signal interference. In some embodiments, the electrochemical module will have an air-tight plug 502 for connecting a vacuum pump. In some embodiments, two boards are used for each electrochemical module, a board for the top block 104 and a board for the bottom block 106. The connection board will have one or more connectors (such as, e.g., DB 9 connector) to facilitate easy plug-in connection of the cables with multiple wires.

In some embodiments, the design can be seen as a holding box which allows for stable and easy connections. A base 510 and a cover 512 for the connection box are shown. One PCB 508 is supported and fixed at the lower part of the box. The electrochemical module can be put in the position inside the box with a matching position. When the cover of the box is closed, the upper PCB board 506 will have its spring plungers pressed, so they will in touch with electrochemical screws on the top of the electrochemical blocks, such as electrochemical block screws 408 in FIG. 4. The same is true for bottom PCB board spring plungers when the electrochemical module is put in place inside the connection box. Supporting screws 514 in the illustration are screws to connect the supporting poles with PCB boards.

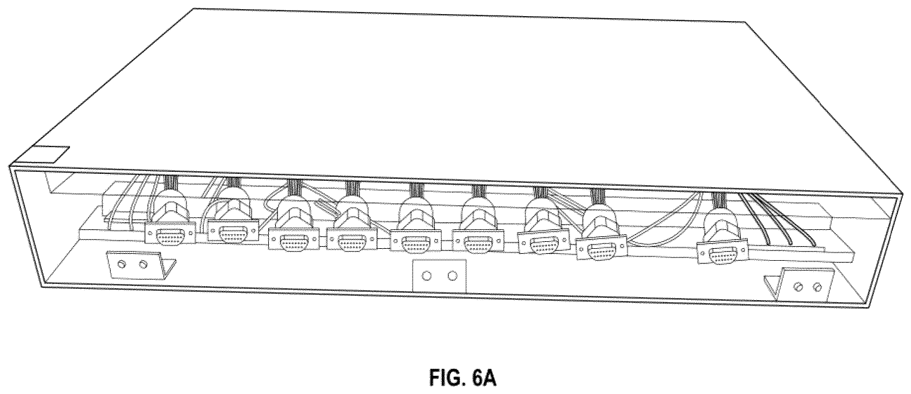

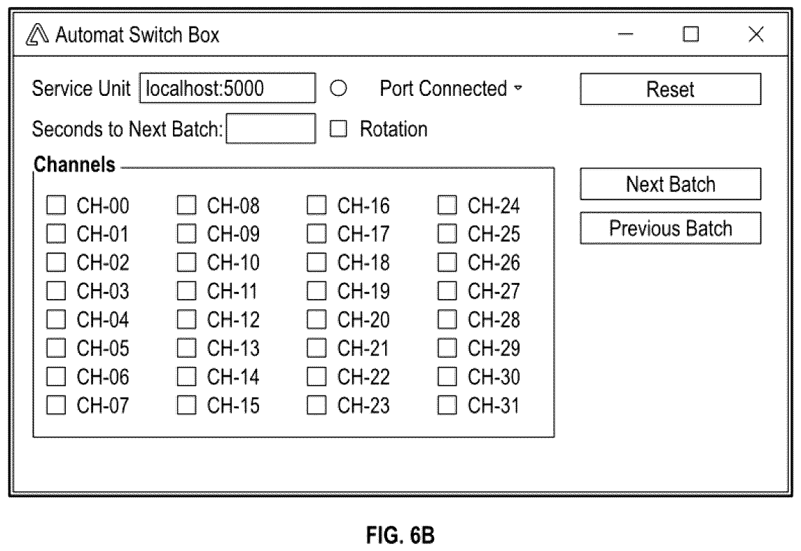

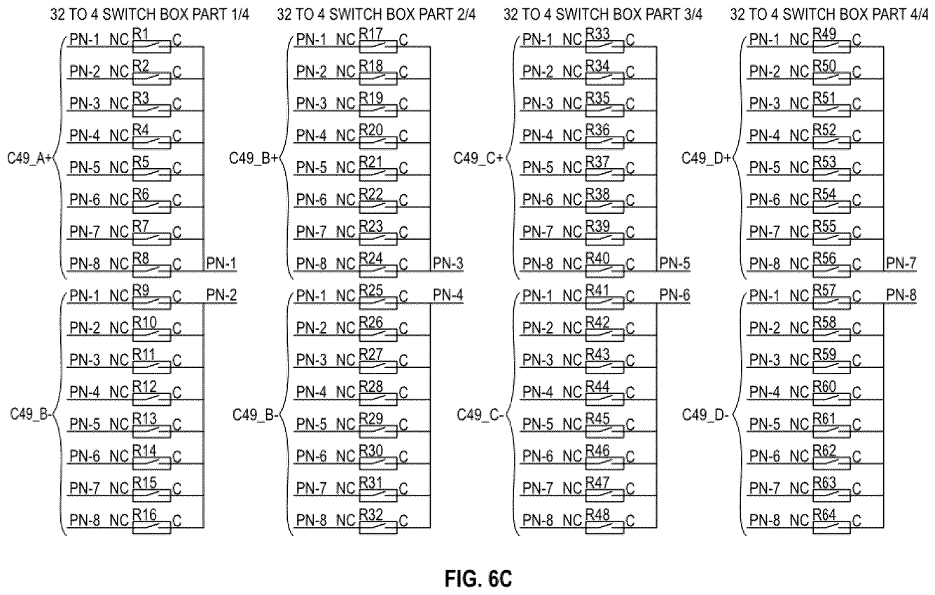

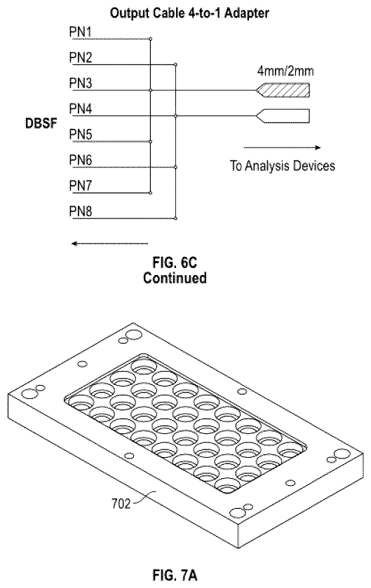

FIGS. 6A, 6B, and 6C illustrate exemplary embodiments of an automatic switch box.

FIG. 6A illustrates an exemplary embodiment of an automatic switch box. The electrochemical module 102 can have many channels (e.g., 32 channels), but conventional potentiostats usually have only 1 to 4 channels. In some embodiments, in order to allow the measurement of multiple channels according to a high-throughput measurement process, an automatic channel switch box is included within the electrochemical testing system. In some embodiments, the switch box includes a solid-state relay board with control software. In various embodiments, the switch box channels can be, e.g., manually switched via a click switch button on a graphical user interface (“GUI”); can be configured for automatic channel-switching via a timer; or can be configured for automatic channel switching through one or more software commands.

FIG. 6B illustrates an exemplary embodiment of a control software interface for an automatic switch box. In some embodiments as illustrated, the switch box can be configured by software as 32 inputs (as illustrated, channels 00 through 31) to be routed to 4 outputs. In some embodiments, the switch box can be configured as 32 inputs to 1 output. Many other such switching and routing configurations can be contemplated.

FIG. 6C illustrates a diagram representing an exemplary wiring configuration for an automatic switch box. In the illustrated wiring configuration, a 32-channel automatic switch box is configured. In the top section, 32 inputs are routed to 4 outputs. In the bottom section, 32 inputs are routed to 1 input. In some alternative embodiments, 1 input can be routed to 1 output for either or both sections, i.e., an individual channel can be routed to an individual channel in a 1-to-1 fashion. Various other alternative embodiments with different configuration may be contemplated.

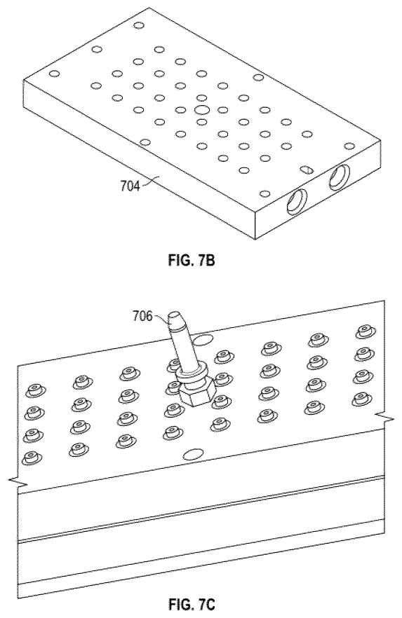

FIG. 7A illustrates a top view of a bottom block 702, wherein the top block can be fastened upon the bottom block 702. When a top block and bottom block are fastened together, an electro-chemical module is created which contains a number of channels, e.g., 32 channels as illustrated in this example. In various embodiments, both the top and lower blocks may be made out of Teflon, to ensure that every channel is isolated, and each can have a number of holes that, when aligned, form the number of channels. For example, 32 holes are present in the example, and when aligned, the holes form the 32 channels. In some embodiments, each channel mimics a battery cell, with anode and cathode connections in the upper and lower block, as well as electrolyte samples sandwiched in between to carry out the charge transport between both electrodes. In the illustrated example, the holes may be configured to have a T-shaped electrode inserted. One example of such a T-shaped electrode is illustrated as the T-shaped component 306 in FIG. 3. It is understood that the electro-chemical module is not limited to 32 channels and may have any number of channels. In some embodiments, a bottom block may include, e.g., 32 wells into which recipe instances prepared by a robotic preparation module may be deposited—as well as an inserted T-shaped electrode component.

In some embodiments, electrochemical materials (e.g., electrolyte) are placed between the top and bottom blocks. Spring assembly allows for conductivity for the electrolyte material, and then measurements are taken.

In some embodiments, automated insertion of electrochemical materials may be performed using a robotics driven system or other form of automation. In some embodiments, the bottom block is placed on a deck of a robot, and a standard electrolyte plate is placed onto the deck of the robot. The robot then is configured to add the electrolyte to each well of the block. In some embodiments, a top block can then be placed down by the robot in order to seal the block.

FIG. 7B illustrates a top view of a top block 702. The top block is configured to be fastened onto the bottom block shown in FIG. 7A.

In some embodiments, a spring is pressed down upon the top and bottom blocks being fastened together. In some embodiments, a glide hole is placed on the assembly. When the spring is extended with some force, the top electrode will come into contact with the bottom electrode, when looking at the top block and bottom block together. This results in a plunger being pushed down when the top block is connected to the bottom block, and this results in a connection being formed from the electrode to the electrolytic material.

Both fastened upper-lower block pairs are situated in a tray. The upper-lower block pairs simulate up to 32 channel battery cells with different recipes prepared and deposited by a robotic preparation module, such that a robotic testing module may perform one or more tests on each channel.

FIG. 7C illustrates a top view of a top and bottom block fastened together. An air-tight plug in the center allows for the connection of a vacuum pump, as described above.

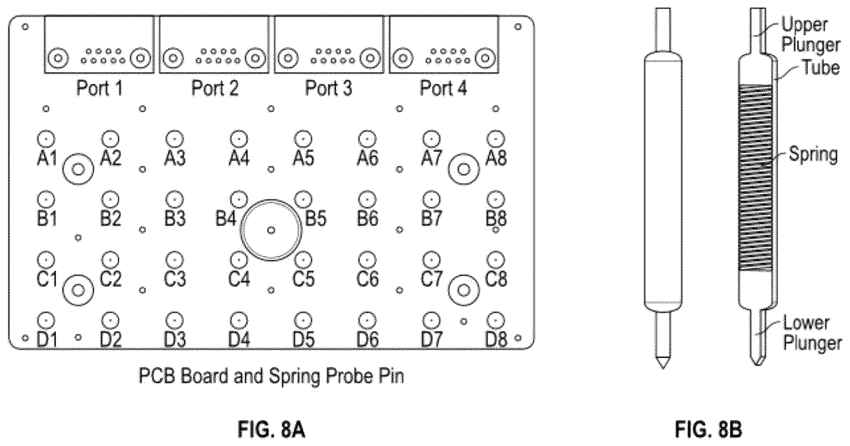

FIG. 8A illustrates a PCB board representing an N×M matrix of testing cells. In the illustrated example, a 4×8 matrix of 32 testing cells is shown. In addition, in some embodiments, four connection points are provided, each of which is used to affix the PCB board to a pole (e.g., a standoff) attached to a cover for the PCB board. In some embodiments, ports 1, 2, 3, and 4 are present. These ports are lined up with the switch box, which uses DB9 connectors. The ports are configured to exactly match the switch box. As illustrated, each of the four ports has nine connectors. In some embodiments, not all of these connectors are used. For example, eight connectors may be used to represent eight channels coming out of each port, for a total of 32 channels.

FIG. 8B illustrates a plunger which connects to each of the receiving wells. The plunger provides electrical connection, as described above. In differing embodiments, plungers of different sizes may be used. An upper plunger tube, spring, and lower plunger are illustrated on the plunger.

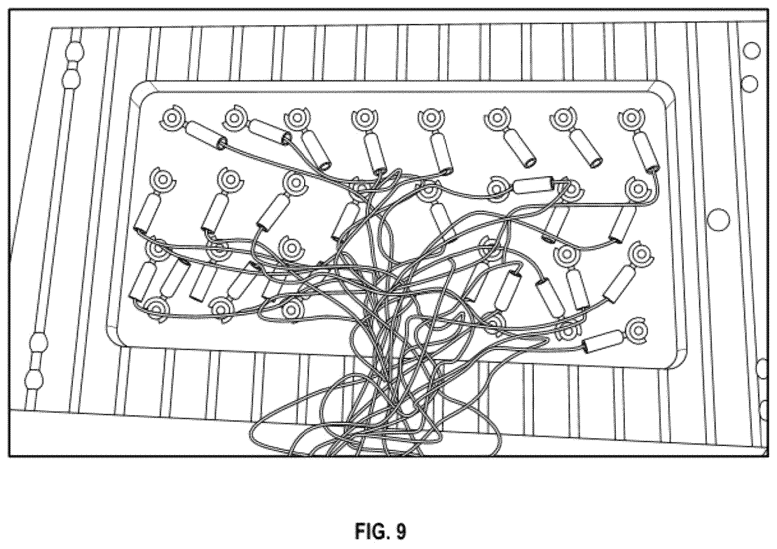

FIG. 9 illustrates a prior art embodiment of a 32-channel electrochemical block, with manual connections per channel. As illustrated, a wire is manually attached to each of the 32 channels, and the wires are connected to a switch box.

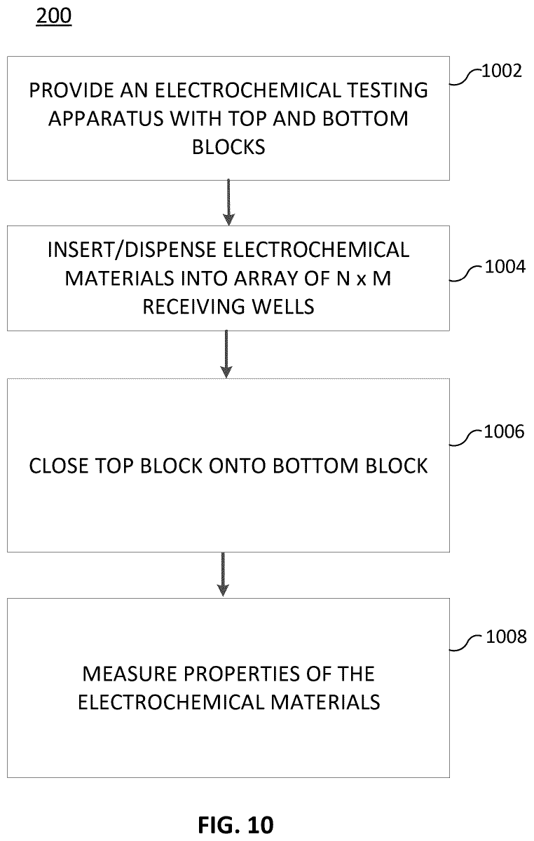

FIG. 10 is a flowchart illustrating an exemplary method for multi-channel matrix-based electrochemical testing, in accordance with some embodiments.

At step 1002, the system provides an electrochemical testing apparatus, i.e., an electrochemical testing module, with top and bottom blocks. The bottom block is an electrochemical block which includes a first array of N×M receiving wells. The top block is an electrochemical block which includes a second array of N×M chambers. Each of the N×M chambers includes an electrical connector inserted into the chamber.

In some embodiments, the electrochemical testing apparatus includes a switch box configured to switch between testing a group of one or more of the N×M testing cells, as described above. In some embodiments, the switch box is configured to automatically switch between the group of the one or more of the N×M testing cells via control software. In other embodiments, the switch box is configured to automatically switch between the group of the one or more of the N×M testing cells via a configurable timer. In other embodiments, the switch box is configured to be manually switched between the group of the one or more of the N×M testing cells via a switch button.

At step 1004, the system inserts electrochemical materials into the first array of N×M receiving wells, as described above. This step involves inserting, into the N×M receiving wells of the bottom block, one or more electrochemical materials to be tested.

In some embodiments, the electrochemical materials are inserted prior to closing the top block onto the bottom block in step 1006. In some embodiments, the bottom block is placed onto the deck of a robot, such as a robot that is configured to operate based on artificial intelligence (“AI”) methods, such as machine learning (“ML”) or neural network-based AI techniques, e.g., recurrent neural networks and other neural networks.

For example, an electrolyte plate (containing electrolyte as the electrochemical materials to be tested) is placed onto the deck of the robot. In some embodiments, electrolytes to be tested are pre-formulated, while in other embodiments the electrolytes are in-situ formulated by the robot. The robot will facilitate the dispensing of the electrolyte into the N×M receiving wells. Electrolyte is thus added to each well of the block. Once the electrolyte is fully added, then the system can proceed to step 1006.

At step 1006, the system closes the top block onto the bottom block, as described above. This step involves closing or fastening the top electrochemical block onto the bottom electrochemical block. When the top and bottom electrochemical blocks are closed, the N×M receiving wells and N×M chambers are aligned, thereby forming N×M testing cells. Once the top and bottom blocks are fastened together, the electrochemical materials are present between the top and bottom blocks, within the testing cells.

In some embodiments, before closing the top electrochemical block onto the bottom electrochemical block, the system inserts a bottom electrode device into each of the receiving wells to be tested, and inserts a top electrode device into each of the corresponding chambers. The top and bottom electrode devices are configured to connect with each other when the top electrochemical block is closed onto the bottom electrochemical block. In some embodiments, a washer separator component is inserted for liquid electrolyte measurement.

In some embodiments, a spring assembly allows for conductivity for the electrochemical materials, which allows the electrochemical materials to be measured with respect to one or more properties as in step 1008 below. In some embodiments, the spring assembly is made of metallic material in order to provide conductivity. In some embodiments, the material is highly conductive material, such as, e.g., copper. The spring is pressed down when the top block is closed onto the bottom block. In some embodiments, a glide hole is present on the spring assembly. When the spring is extended with some force, the top electrode will come into contact with the bottom electrochemical material (e.g., electrolyte or other suitable electrochemical material). The plunger is pushed down during the connecting of the top block to the bottom block. This pushing down of the plunger presses the electrochemical material down against the electrode, and this is what forms the connection of the electrode to the electrochemical material.

In some embodiments, a sterile, clean environment (e.g., at laboratory clean standards) is present or generated. This can include the electrochemical module being operated in an air-free and moisture-free environment. In some embodiments, after closing the top block onto the bottom block but prior to measuring the properties of electrochemical materials in step 1008, the system evacuates air from the internal channels and the top and bottom electrochemical blocks using a vacuum source, in order to provide a vacuum-tight seal between the top and bottom blocks. In some embodiments, a socket is used to connect the electrochemical module to a vacuum in order to create the vacuum-sealed environment. In some embodiments, a metal hose is attached at the center of the top and/or bottom blocks, and this is where the block(s) are connected to a vacuum pump. In some embodiments, a metal screw is present which will tighten the spring assembly and electrodes. In some embodiments, when the top and bottom blocks are closed together, the inside will form a chamber that is vacuum-tight and moisture-free. In some embodiments, air may be captured within this chamber. In some embodiments, another hole may be present on the module (e.g., on one or both blocks) which provides the vacuum chamber, for the entire multichannel environment. In some embodiments, this hole is sealed via O-ring or other supporter. In some embodiments, channels are sealed individually by O-rings or other supporters. In some embodiments, an O-ring or other supporter may also be added to provide space between the top and bottom block, and the vacuum environment is generated afterward. The O-rings or other supporters used in these embodiments can provide a common space for all channels within the blocks by creating a middle layer of support between the top and bottom layers.

In one example, there are multiple channels and multiple receiving wells, and an entire chamber formed from the top and bottom blocks is vacuum sealed to remove air. In some embodiments, there is no cross-sharing of air between the channels. In some embodiments, the receiving wells can each be individually sealed.

In some embodiments, the system provides a gasket seal between the top and bottom electrochemical block. In some embodiments, the system affixes the top electrochemical block to the bottom electrochemical block using one or more fasteners. In some embodiments, an O-ring is used to facilitate the sealing, as described above.

In some embodiments, the system provides a seal between the top and bottom electrochemical blocks via an air valve filled with an inert gas or dry material.

In some embodiments, a connection box as described above provides connection to measuring equipment for all 32 channels and consists of a number of channels with the same number of wires on top and on the bottom of the connection box (e.g., 32 channels in a multichannel case, with 32 wires on top and 32 wires on bottom). In some embodiments, a cable is connected to the connection box, and then extended to a switch box.

At step 1008, the system measures the electrochemical materials inserted in the N×M receiving wells, as described above. This step involves measuring one or more properties of the electrochemical materials inserted into the N×M receiving wells. In various embodiments, this testing and measurement may be performed manually, automatically, or semi-automatically. In some embodiments, testing is performed automatically by an AI-based robotics driven system. In some embodiments, this system includes one or more of a machine learning framework, a knowledge database that includes training data, a robotic preparation module, and a robotic testing module. Various embodiments of this robotics driven system can be centralized, autonomous, combinatorial, and closed-loop, and can combine machine learning and robotic high-throughput automation. In some embodiments, this system can be implemented to discover new high-performance battery materials and improve existing battery materials, including one or more recipe components for the electrolyte (polymer/liquid), the cathode and the anode, as well as battery devices. In other embodiments, this system can be implemented to discover high-performance non-battery materials as well, including for use in, e.g., capacitors, super capacitors, ceramic electrolytes, dielectric material, or any other suitable electrochemical materials to be used in non-battery contexts.

In some embodiments, the robotics driven system generates, via the machine learning model, a number of proposed different recipes of battery materials, optimizing for at least one objective function. Instances of the different recipes of battery materials are prepared and deposited into an electrochemical module by a robotic preparation module. A robotic testing module executes a plurality of formulation characteristic tests on each deposited recipe instance and updates the machine learning model with a result of at least one of the formulation characteristic tests.

Further description, embodiments, and examples of such an AI-based, robotics driven system is disclosed in Patent Application No. 63/040,133, entitled, “Materials Artificial Intelligence Robotics-Driven Methods and Systems”, which is hereby incorporated by reference in its entirety.

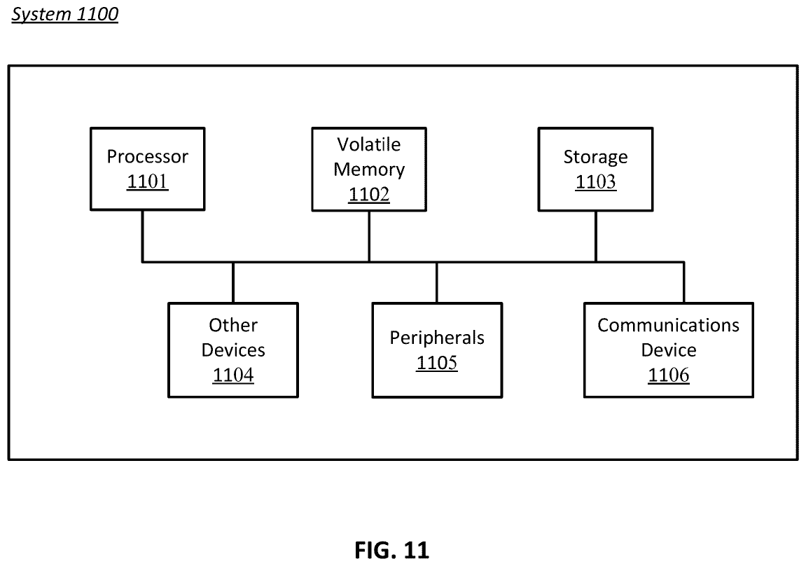

FIG. 11 is a diagram illustrating an exemplary computer that may perform processing in some embodiments. Exemplary computer 1100 may perform operations consistent with some embodiments. The architecture of computer 1100 is exemplary. Computers can be implemented in a variety of other ways. A wide variety of computers can be used in accordance with the embodiments herein.

Processor 1101 may perform computing functions such as running computer programs. The volatile memory 1102 may provide temporary storage of data for the processor 1101. RAM is one kind of volatile memory. Volatile memory typically requires power to maintain its stored information. Storage 1103 provides computer storage for data, instructions, and/or arbitrary information. Non-volatile memory, which can preserve data even when not powered and including disks and flash memory, is an example of storage. Storage 1103 may be organized as a file system, database, or in other ways. Data, instructions, and information may be loaded from storage 1103 into volatile memory 1102 for processing by the processor 1101.

The computer 1100 may include peripherals 1105. Peripherals 1105 may include input peripherals such as a keyboard, mouse, trackball, video camera, microphone, and other input devices. Peripherals 1105 may also include output devices such as a display. Peripherals 1105 may include removable media devices such as CD-R and DVD-R recorders/players. Communications device 1106 may connect the computer 100 to an external medium. For example, communications device 1106 may take the form of a network adapter that provides communications to a network. A computer 1100 may also include a variety of other devices 1104. The various components of the computer 1100 may be connected by a connection medium such as a bus, crossbar, or network.

It will be readily understood by one of skill in the art that one or more alternatives, extrapolations, and/or additions to some or all of the disclosed embodiments may be practiced without departing from the spirit and the scope of the present disclosure. In particular, the various features, devices, apparatuses, subsystems, systems, and methods disclosed herein provide faster, more efficient, and less costly methods of measuring the properties of electrochemical materials. These objectives can be furthered with additional improvements, features, and/or components to the various embodiments detailed above. In some arrangements, further improvements can be made to the foregoing systems and methods to account for various drawbacks or inefficiencies of these systems and methods.

For example, some improvements can result in greater normalization or conformity between testing cells in a multi-cell electrochemical block or device, such as the module or device created when top electrochemical block 104 and bottom electrochemical block 106 are fastened together or otherwise combined to form multiple testing cells, such as that which is shown in FIGS. 1, 2 and 4 above. As will be readily appreciated by those of skill in the art, it can be important during the testing of multiple different battery materials for multiple testing cells in a multi-cell electrochemical testing block or device to be identical or as similar as possible. Slight differences between one or more attributes or parameters of the testing cells can result in undesirable effects to the measured properties of the battery materials being tested in all of the testing cells. Accordingly, it is desirable for attributes or parameters of the testing cells to be controlled as much as possible. These can include, for example, internal volume, internal pressure, distance between testing cell electrodes, and other factors.

Unfortunately, it can be difficult to control for all factors that can affect measured results from one testing cell to another such that differences in the measurements taken in all testing cells are due only to differences in the battery materials themselves. Clamping or fastening top electrochemical block 104 to bottom electrochemical block 106 during a routine testing process, for example, can result in slight bowing or warping of the electrochemical block material at areas away from exactly where the blocks are fastened together. For example, where the electrochemical blocks are clamped or fastened together at or around the block edges, slight bowing of the block material can occur towards the center of the electrochemical blocks. This can then result in slight differences from one testing cell to another, such as internal cell volume, surface area, pressure, and distance between electrodes, among other testing cell properties. Differences like these can then affect the measurements of the battery materials being tested. Other issues that can arise during routine testing procedures of electrochemical devices having multiple testing cells can include, for example, slight differences in testing cell dimensions, slight amounts of residue remaining after cleaning block materials, and weakened seals or cell leakage from one testing cell to another, among other issues, all of which can affect testing cell volume, surface area, pressure, distance between electrodes, and/or one or more other parameters. These and other issues can be eliminated or minimized by way of one or more additional features and/or components that can result in greater conformity or normalization between testing cells in a multi-cell electrochemical testing block or device.

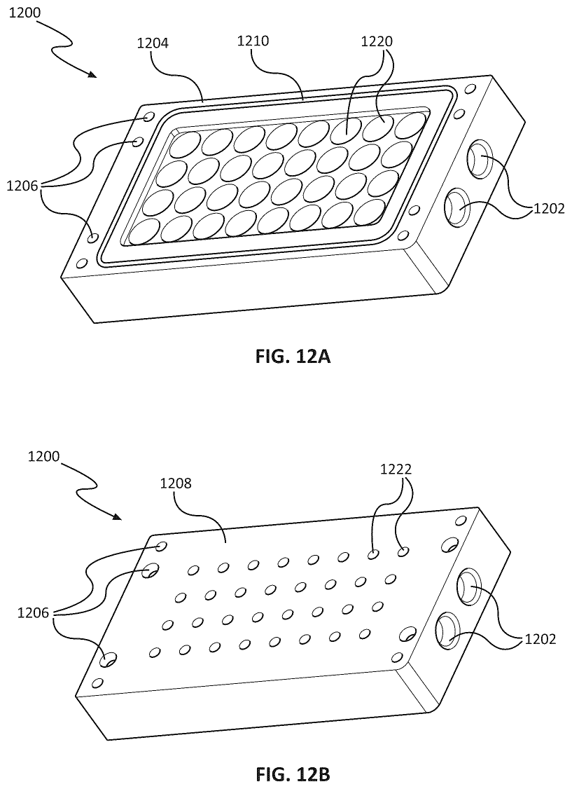

Transitioning now to FIGS. 12A-12B, an alternative bottom electrochemical block for an electrochemical testing device is shown in top perspective and bottom perspective views respectively. Bottom electrochemical block 1200 can be substantially similar in some ways to bottom electrochemical block 106 as illustrated and described above. For example, bottom electrochemical block 1200 can have one or more vacuum openings 1202 along one or more sides to provide access to vacuum channels within the block, which vacuum openings can be similar to openings 202 in top block 104 as shown above. Bottom electrochemical block 1200 can include top surface 1204 with multiple openings 1206 configured to accommodate coupling components that can fasten, clamp, clip, latch, or otherwise couple the bottom electrochemical block to a top electrochemical block (not shown), such as that which is illustrated and described above as top electrochemical block 106. Bottom electrochemical block 1200 can also include bottom surface 1208 with multiple small openings 1222 therethrough at the bottom of each well. Each opening 1222 can allow for electrical contact to a bottom electrode within each well.

Rather than using a flat gasket to form a seal between top and bottom electrochemical blocks as shown above, bottom electrochemical block 1200 can have a rectangular shaped O-ring 1210 arranged near its outer edges and around all of wells 1220. In some arrangements, a groove or indent can be formed along top surface 1204 of bottom electrochemical block 1200 and/or a similar groove or indent along a corresponding bottom surface of a top electrochemical block (not shown) to help locate O-ring 1210 and facilitate a proper seal between the blocks.

Multiple wells 1220 can extend downward into bottom electrochemical block 1200 from its top surface 1204, as shown. These wells 1220 can be identical or substantially similar to the wells in bottom electrochemical block 106 illustrated and described above and can align and combine with chambers in a corresponding top electrochemical block (not shown) to form testing cells when the blocks are fastened together, as noted above. As in the case of bottom block 106 shown above, each of multiple wells 1220 can be configured to receive therein a prepared liquid electrolyte suitable for electrochemical testing. Each of multiple wells 1220 can also be configured to receive a well insert therein, which well insert can contain the prepared liquid electrolyte, as set forth in greater detail below.

As shown in FIG. 12A, multiple wells 1220 can be arranged into a N×M grid or matrix format, such as a 4×8 matrix to provide 32 wells as shown. Of course, more or fewer wells can be provided in a given bottom electrochemical block. It will also be understood that multiple wells 1220 can be arranged differently than in a matrix as shown. For example, multiple wells can be arranged in a line, in concentric circles, or in any other suitable pattern. Of course, where the multiple wells are arranged differently, then similar adjustments would be needed for the corresponding chambers in a mating top electrochemical block, as well as for any PCB or other testing component with circuitry and probes configured to contact the electrical contacts at the top and bottom of the electrochemical testing device.

As will be readily appreciated, each bottom block well 1220 (and thus each testing cell formed by a well and a corresponding top block chamber) can be arranged to contain a different electrochemical material for rapid testing of all different materials within each well, testing cell, and overall electrochemical testing device. For accurate testing results, it is desirable that every testing cell should have the same internal testing volume, the same cell thickness, the same even pressure between top and bottom electrodes, and the same amount of rust, residue, or other impurities (ideally none). Accordingly, it is desirable to apply even pressure across all wells and testing cells when fastening or otherwise clamping the bottom and top electrochemical blocks together after placing different electrochemical materials to be tested into each well.

Unfortunately, even when made out of a rigid non-reactive material, one or both of the top and bottom electrochemical blocks can bow or bend slightly when fastening, clamping, or otherwise coupling these blocks together to form an electrochemical testing device. This can then result in uneven pressures across the multiple wells and testing cells, which in turn can affect material property measurements. Further, uneven pressures can also result in slight leakages of liquid electrolyte materials, which can further affect material property measurements. In situations where liquid electrolytes in particular are being tested across multiple wells and testing cells, these issues can be eliminated or minimized by using well inserts to facilitate normalizing multiple testing cells such that each testing cells with a well insert provides electrochemical testing parameters that are substantially identical.

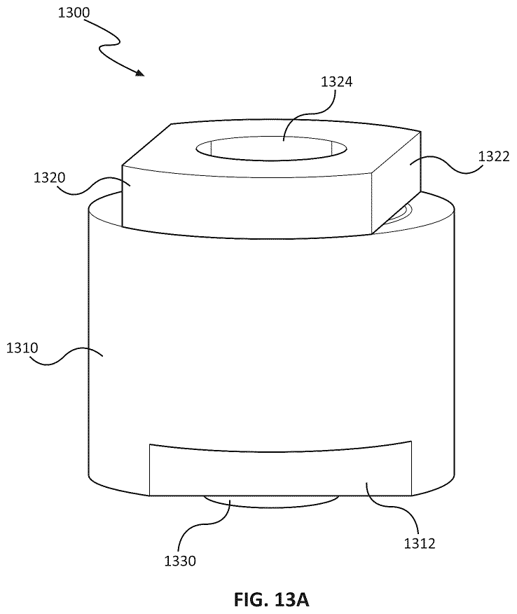

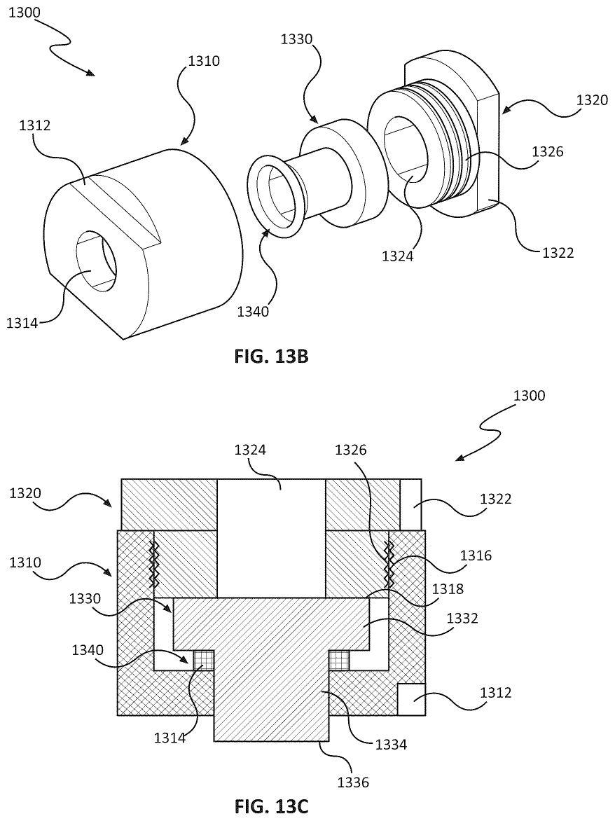

Moving next to FIG. 13A, an example well insert for an electrochemical testing device is illustrated in front perspective view. Well insert 1300 can be configured to be removably placed within a testing cell such that it facilitates normalizing that testing cell to provide electrochemical testing parameters that are substantially identical. Where an identical or substantially similar well insert 1300 is placed into each well (i.e., testing cell), then all of the testing cells with well inserts can experience the same internal testing volume, pressure, distance between electrodes, and other testing cell parameters regardless of any electrochemical block bowing or other imperfections.

Well insert 1300 can be sized and shaped to be removably placed within a well 1220 of bottom electrochemical block 1200 as shown and described above. Well insert 1300 can include several items that can be disassembled and reassembled, such as outer spacer 1310, inner spacer 1320, and inner electrode 1330. Outer spacer 1310 and inner spacer 1320 can have threaded regions configured to mate such that these items can be rotatably assembled together and removed from each other. Flat indents 1312 on outer spacer 1310 and flat surfaces 1322 on inner spacer 1320 can facilitate such relative rotation either by hand or by using tools

Inner spacer 1320 can have a top opening 1324 at a top surface thereof configured to accept a prepared liquid electrolyte material therethrough while well insert 1300 is fully assembled. The liquid electrolyte can be inserted through top opening 1324 and into an internal testing volume within well insert 1300. This internal testing volume can be identical or substantially similar for all well inserts 1300 such that bowing or bending of the electrochemical block(s) does not affect testing cell parameters. Similarly, the distance between the top surface of inner spacer 1320 and the bottom surface of inner electrode 1330 can be identical or substantially similar for all well inserts 1300. Accordingly, testing cell parameters such as internal testing volume, pressure, and distance between electrodes can be normalized across all testing cells when identical or substantially similar well inserts 1300 are placed into every well (and thus testing cell). This normalization or control can also result in elimination of or equal minimizing of liquid electrolyte leakage from every testing cell during testing of different materials.

FIGS. 13B and 13C show the well insert of FIG. 13A in perspective exploded and side cross-section views respectively. Outer spacer 1310 can have a bottom opening 1314 through a bottom surface thereof such that the bottom surface 1336 of inner electrode 1330 can protrude therethrough. Outer spacer 1310 can have a threaded region 1316 around and near the top of an internal wall that is configured to mate with a threaded region 1326 on an external wall of inner spacer 1320 such that the inner and outer spacers can be rotatably disassembled or rotatably assembled and tightened firmly together. As will be readily appreciated, the ability to disassemble and reassemble components of well insert 1300 can facilitate the easy cleaning and sterilization of these parts after the insertion and testing of different liquid electrolyte materials.

Outer spacer 1310 can have an internal cavity 1318 configured to accept portions of inner spacer 1320 and inner electrode 1330 therein, as shown in FIG. 13C. Inner electrode 1330 can be within well insert 1330 and can effectively be positioned between outer spacer 1310 and inner spacer 1320, as shown. Inner electrode 1330 can include an upper flange portion 1332 and a lower protrusion portion 1334 configured to extend through bottom opening of outer spacer 1310. O-ring 1340 can be arranged around lower protrusion portion 1334 and situated between upper flange portion 1332 and the bottom inner surface of outer spacer 1310 within its internal cavity 1318. When situated as shown in FIG. 13C, O-ring 1340 can effectively provide a seal that prevents or minimizes liquid electrolyte material from leaking from inside well insert 1300.

In various arrangements, top opening 1324 of inner spacer 1320 can form the entire internal testing volume of well insert 1300 such that all inserted liquid electrolyte fills this volume formed by the top opening in the inner spacer. In such instances, the bottom surface of inner spacer 1320 can contact and lay flush against the top surface of inner electrode 1330 (not shown in FIG. 13C) and a bottom surface of a top electrode (not shown) can contact and lay flush against the top surface of the inner spacer where the liquid electrolyte was inserted.

In other arrangements, the bottom surface of inner spacer 1320 does not reach and contact the top surface of inner electrode 1330 such that some or all of the volume of internal cavity also becomes part of the internal testing volume of well insert 1300.

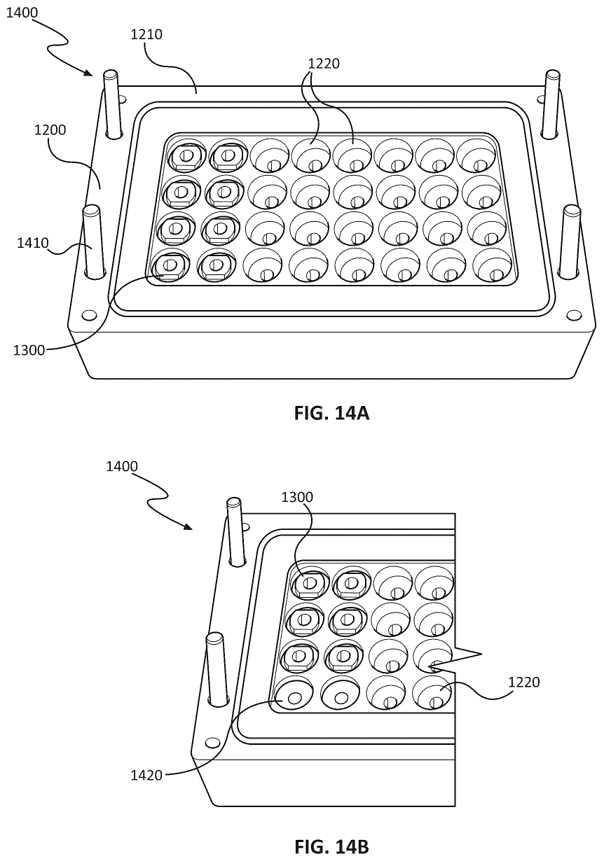

Continuing with FIG. 14A, a bottom electrochemical block is shown in top perspective view as being partially assembled with well inserts. Arrangement 1400 reflects the bottom electrochemical block 1200 as illustrated and described above with well inserts 1300 placed into some of its 32 wells while other wells still remain empty. Multiple bolts 1410 extend through openings along the edges of bottom electrochemical block 1200 and are ready to receive a corresponding top electrochemical block (not shown) to be fastened thereupon. Once the top block is placed onto bolts 1410, then one or more plates, washers, and nuts can be applied to firmly fasten the top and bottom electrochemical blocks together. Various alternative top to bottom block fastening arrangements are also possible, and these can include, for example, additional or alternatively placed bolts and/or screws, fastening clips at one or more edges, and/or one or more clamps arranged to clamp all edges together around the perimeter of both blocks, among other suitable fastening or coupling arrangements.

FIG. 14B illustrates in close up top plan view the same bottom electrochemical block with wells at various stages of assembly. As shown, some wells 1220 are still empty such that the entire internal cavity and bottom opening of the well can be seen. Other wells have had well inserts 1300 placed therein. At an intermediate step, some wells have had a bottom electrical plate arrangement 1420 placed into the bottom of the well prior to placing a well insert 1300 on top of the bottom electrical plate. Such a bottom electrical plate arrangement 1420 can provide a flat surface that facilitates an electrically conductive contact between the bottom surface of the inner electrode and an electrical contact that extends through the bottom opening of the well for contact with a testing probe or other system component. This bottom electrical plate arrangement 1420 can include a plate, an O-ring beneath the plate, and a bolt that extends through the bottom opening of the well such that an external nut can be placed on the bolt to hold it firmly in place and prevent leakage of the liquid electrolyte through the bottom opening of the well.

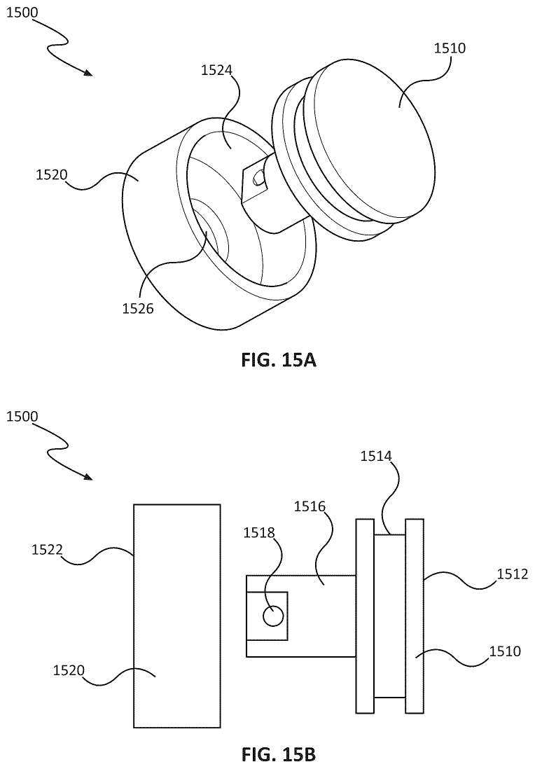

FIGS. 15A and 15B illustrate an example top electrode for an electrochemical testing device in perspective exploded view and side exploded views respectively. As will be readily appreciated, the inner electrode 1330 of well insert 1300 can serve as a bottom electrode for a testing cell created with the well insert placed therein. A corresponding top electrode is then needed to be able to conduct measurements across the testing cell. Such a top electrode 1500 can be placed within and/or coupled to a chamber within an associated top electrochemical block. Such a top electrochemical block can be identical or substantially similar to that which is illustrated and described above in previous embodiments.

Top electrode 1500 is one example of such an electrode that can be located within and coupled to a top electrochemical block chamber. Top electrode 1500 can include electrode component 1510 and electrode housing 1520 configured to couple with the electrode component. Electrode component 1510 can include a flat bottom surface 1512 that can be configured to contact and lay flush against the flat top surface of a corresponding inner spacer 1320 of a well insert 1300 as shown above. In some arrangements, flat bottom surface 1512 can cover the entire top opening 1324 of the inner spacer 1320 such that the internal testing volume of the well insert is closed off thereby. Electrode component 1510 can include a groove 1514 spaced above from its flat bottom surface 1512, with this groove being configured to accommodate an O-ring therein to facilitate forming a seal between electrode component 1510 and the inner wall of electrode housing 1520 such that no liquid electrolyte material can lead therethrough.

Electrode component 1510 can also include an elongated portion 1516 configured to protrude through a top opening 1526 in electrode housing 1520. A keyhole or opening 1518 through a distal end of elongated portion 1516 can facilitate locking the electrode component in place once this opening passes through electrode housing top opening 1526. As shown, electrode housing 1520 can include a top surface 1522 on the exterior of top electrode 1500 and an internal cavity 1524 that is sized and shaped to accommodate electrode component 1510 therein.

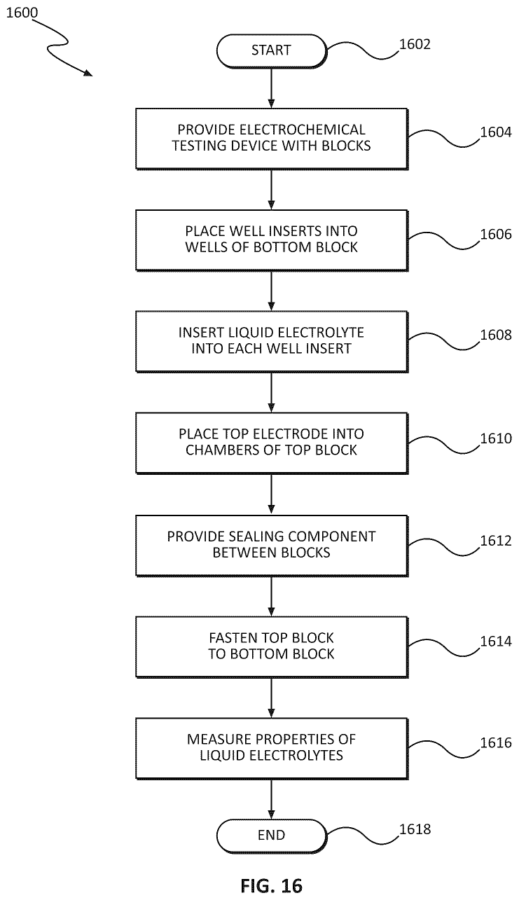

Lastly, FIG. 16 illustrates a flowchart of an example method of testing liquid electrolytes. Method 1600 can be similar in some regards to the method set forth in FIG. 10 above, although some differences between methods can exist due to the use of well inserts and other details in this alternative method. It will be understood that method 1600 provides one example of testing liquid electrolytes for purposes of illustration, and that various other steps, features, and details are not provided here for purposes of simplicity. Some or all steps of method 1600 can be performed automatically, such as where one or more robotic components are configured to perform some or all of the process steps.

After a start step 1602, a first process step 1604 can involve providing a suitable electrochemical testing device, such as that which is set forth above. Such a device can include, for example, top and bottom electrochemical blocks, a plurality of well inserts, electrodes for every testing cell, sealing components, and fastening components, among other possible items.

A subsequent process step 1606 can involve placing one of the well inserts into each of the multiple wells of the bottom electrochemical block. This can involve the use of well inserts that are identical or substantially similar. Each well insert can thus be configured to facilitate normalizing its respective testing cell when placed therein such that each of the multiple testing cells with a well insert will provide electrochemical testing parameters that are substantially identical.

At the next process step 1608, a liquid electrolyte can be inserted into each well insert as it is within its well in the bottom electrochemical block. This can be done by inserting the liquid electrolyte through an opening at the top of the well insert such that the liquid electrolyte fills an internal testing volume within the well insert. As noted above, some or all of the liquid electrolytes can be different from each other for purposes of electrochemical materials testing.

The following process step 1610 can involve placing a top electrode component into each of the multiple chambers of the top electrochemical block. As noted above, each of the well inserts can include a corresponding bottom electrode component therein such that opposing electrodes are then created for each testing cell.

Subsequent process step 1612 can involve providing a sealing component between the top and bottom electrochemical blocks. This can be an O-ring as noted above in FIGS. 12A and 14A. In some arrangements, a groove in one or both of the top and bottom electrochemical blocks can provide a good location for the O-ring and can help to facilitate an adequate seal between the blocks. Alternatively, a flat gasket or other suitable sealing component can be used.

At the next process step 1614, the top electrochemical block can be fastened or otherwise coupled to the bottom electrochemical block. This can be done by using bolts and nuts, clamps, brackets, clips, and/or any other suitable fastening, clamping, or coupling components. As noted above, fastening the blocks together can result in a seal between the top and bottom blocks, such as at the gasket, O-ring, or other suitable sealing component. In some arrangements, process step 1614 can include closing the top electrochemical block onto the bottom electrochemical block such that the multiple chambers align with the multiple wells to form multiple testing cells prior to fastening the top and bottom blocks together.

Process step 1616 can then involve measuring one or more properties of each of the liquid electrolytes within the multiple testing cells. As noted above, the liquid electrolytes can be inserted into the well inserts within the testing cells such that they fill an internal testing volume within the well inserts. Measuring these properties can be done by way of the various test equipment items set forth above. The method can then end at end step 1618.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read-only memory (“ROM”), random access memory (“RAM”), magnetic disk storage media, optical storage media, flash memory devices, etc.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details but rather is to be defined by the scope of the appended claims.

What is claimed is:

1. An electrochemical testing device, comprising:
a bottom electrochemical block having multiple wells, wherein each of the multiple wells is configured to receive therein a battery material suitable for electrochemical testing;
a top electrochemical block having multiple chambers, wherein the top electrochemical block is configured to be fastened onto the bottom electrochemical block such that the multiple chambers align with the multiple wells to form multiple testing cells; and
a plurality of well inserts configured to be removably placed within the multiple testing cells, wherein each well insert is configured to facilitate normalizing its respective testing cell when placed therein such that each of the multiple testing cells with a well insert provides electrochemical testing parameters that are substantially identical.

2. The electrochemical testing device of claim 1, wherein each of the plurality of well inserts are configured to facilitate liquid electrolyte testing.

3. The electrochemical testing device of claim 1, wherein the substantially identical electrochemical testing parameters for each of the multiple testing cells include internal volume, internal pressure, distance between testing cell electrodes, or any combination thereof.

4. The electrochemical testing device of claim 1, wherein each of the plurality of well inserts includes an inner spacer having a top opening through a top surface thereof configured to receive a liquid electrolyte to be tested and an outer spacer removably coupled to the inner spacer such that the inner spacer and outer spacer combine to define an internal testing volume configured to receive the liquid electrolyte therein via the top opening.

5. The electrochemical testing device of claim 4, wherein each of the plurality of well inserts further includes an inner electrode situated between the inner spacer and the outer spacer, the inner electrode having a protrusion with an electrical contact surface that extends through a bottom opening of the outer spacer.

6. The electrochemical testing device of claim 5, wherein each inner electrode forms a bottom electrode and further comprising:
a plurality of top electrodes, wherein each top electrode is located within a chamber of the top electrochemical block such that each testing cell includes a top electrode at the top of the testing cell and a bottom electrode at the bottom of the testing cell.

7. The electrochemical testing device of claim 6, wherein the distance between the top electrode and the bottom electrode is identical for each of the testing cells.

8. The electrochemical testing device of claim 5, wherein each of the plurality of well inserts further includes a sealing component situated about the inner electrode to prevent liquid electrolyte from escaping through the bottom opening of the outer spacer.

9. The electrochemical testing device of claim 4, wherein the outer spacer is removably coupled to the inner spacer by way of threaded arrangements on both of the outer spacer and the inner spacer.

10. The electrochemical testing device of claim 4, wherein the internal testing volume is identical for each of the plurality of well inserts.

11. The electrochemical testing device of claim 10, wherein the internal testing volume for each of the plurality of well inserts remains the same regardless of any variations in the dimensions of the multiple testing cells.

12. The electrochemical testing device of claim 4, wherein the internal testing volume is fully contained within the inner spacer.

13. A well insert configured to be removably placed within a testing cell of an electrochemical testing device, the well insert comprising:
an inner spacer having a top opening through a top surface thereof configured to receive a liquid electrolyte to be tested;
an outer spacer removably coupled to the inner spacer, wherein the inner spacer and outer spacer combine to define an internal testing volume configured to receive the liquid electrolyte therein via the top opening; and
an inner electrode situated between the inner spacer and the outer spacer, the inner electrode having a protrusion with an electrical contact surface that extends through a bottom opening of the outer spacer, wherein the well insert is configured to facilitate normalizing a testing cell within an electrochemical testing device having multiple testing cells such that all testing cells having a well insert situated therein provide electrochemical testing parameters that are substantially identical.

14. The well insert of claim 13, further comprising:
a sealing component situated about the inner electrode to prevent liquid electrolyte from escaping through the bottom opening of the outer spacer.

15. The well insert of claim 13, wherein the outer spacer is removably coupled to the inner spacer by way of threaded arrangements on both of the outer spacer and the inner spacer.

16. The well insert of claim 13, wherein the internal testing volume is fully contained within the inner spacer.

17. The well insert of claim 13, wherein the internal testing volume remains the same regardless of the dimensions of the electrochemical testing device testing cell that the well insert is placed within.

18. The well insert of claim 13, wherein the inner electrode forms a bottom electrode for the testing cell and wherein the top surface of the inner spacer is configured to contact a separate top electrode for the testing cell.

19. A method of testing liquid electrolytes, the method comprising:
providing an electrochemical testing device as recited in claim 1;
placing one of the plurality of well inserts into each of the multiple wells of the bottom electrochemical block;
inserting a liquid electrolyte into each of the removable well inserts;
closing the top electrochemical block onto the bottom electrochemical block such that the multiple chambers align with the multiple wells to form multiple testing cells; and
measuring one or more properties of the liquid electrolytes inserted into each of the well inserts.

20. The method of claim 19, further comprising:
placing a top electrode component into each of the multiple chambers of the top electrochemical block, wherein each of the well inserts includes a corresponding bottom electrode component therein;
providing a sealing component between the top and bottom electrochemical blocks; and
fastening the top electrochemical block to the bottom electrochemical block using one or more coupling components.
